(19) United States
(12) Patent Application Publication
(10) Pub. No.: US 2019/0320869 A1
(43) Pub. Date: Oct. 24, 2019

(54) CLEANING AND STORAGE DEVICE

(71) Applicant: Anthony Leo Klein, Freeport, NY (US)

(72) Inventor: Anthony Leo Klein, Freeport, NY (US)

(21) Appl. No.: 16/378,360

(22) Filed: Apr. 8, 2019

Related U.S. Application Data
(60) Provisional application No. 62/627,012, filed on Feb. 6, 2018.

(51) Int. Cl. A47L 13/51; A47L 13/26

(52) U.S. Cl. CPC A47L 13/51; B08B 11/00; A47L 13/26

(57) ABSTRACT

A sponge cleaning device has a lid for enclosing and hiding a sponge when not in use. The sponge cleaning device has a bottom shelf that can be raised and lowered into a cleaning solution disposed in a base of the device. When the lid is closed, the bottom shelf lowers toward the base, causing a sponge resting on the bottom shelf to be lowered into the cleaning solution. When the lid is opened, the bottom shelf raised out of the cleaning solution and toward a top shelf. The top shelf can be movably disposed to compress the sponge when the sponge is on the bottom shelf and the lid is opened, thus squeezing out cleaning solution from the sponge. The top shelf can be movably disposed to permit the user to access the sponge and remove it from the bottom shelf for use.

### CROSS-REFERENCE TO RELATED APPLICATIONS

This application claims the benefit of priority of U.S. provisional patent application number 62/627,012, filed Feb. 6, 2018, the contents of which are herein incorporated by reference.

### BACKGROUND OF THE INVENTION

### 1. Field of the Invention

Embodiments of the invention relates generally to cleaning and storages devices. More particularly, the invention relates to device configured to store or soak an item, such as jewelry or a sponge, in an enclosed space holding cleaning or sanitizing solution.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The sponge is known to have the highest levels of bacteria in the home and more than the toilet seat. It is used to clean our dishes, pots, pans and silverware. There are many ways to clean a sponge, including hot water, the microwave, or the like. However, these methods may not get the sponge as clean as desired.

In view of the foregoing, there is a need for a novel way to store and clean sponges as well as other items, such as jewelry.

### SUMMARY OF THE INVENTION

Embodiments of the present invention provide a cleaning device comprising a base member having sides extending from a bottom thereof; a lid configured to close against tops of the sides of the base member; a top shelf attached to at least one of the sides of the base member; a lower shelf, positioned below the top shelf; and a plurality of arms interconnecting the lid and the lower shelf, the arms configured to raise the lower shelf to a first position adjacent the top shelf when the lid is open, the arms further configured to lower the lower shelf to a second position adjacent a bottom surface of the base member.

Embodiments of the present invention further provide a cleaning device comprising a base member having sides extending from a bottom thereof; a lid configured to close against tops of the sides of the base member; a top shelf attached to at least one of the sides of the base member; a shelf hinge attaching the top shelf to a back side of the cleaning device; a lid hinge connecting the lid to the back side of the cleaning device at a location above the shelf hinge; a lower shelf, positioned below the top shelf; and a plurality of arms interconnecting the lid and the lower shelf, the arms configured to raise the lower shelf to a first position adjacent the top shelf when the lid is open, the arms further configured to lower the lower shelf to a second position adjacent a bottom surface of the base member, wherein the top shelf is configured to pivot to cause at least a portion of the top shelf to move closer to the lower shelf and away from the lower shelf.

Embodiments of the present invention also provide a method for cleaning and storing an item comprising placing the item on a lower shelf of a cleaning device, the cleaning device including a base member having sides extending from a bottom thereof, a lid configured to close against tops of the sides of the base member, a top shelf attached to at least one of the sides of the base member, the lower shelf positioned below the top shelf, and a plurality of arms interconnecting the lid and the lower shelf, the arms configured to raise the lower shelf to a first position adjacent the top shelf when the lid is open, the arms further configured to lower the lower shelf to a second position adjacent a bottom surface of the base member; closing the lid to cause the item to move into a cleaning solution positioned into the base member; and opening the lid after a cleaning time to move the lower shelf out of the cleaning solution.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 is a front, partially cut-away view of a sponge cleaning device, with the lid open, according to an exemplary embodiment of the present invention;

FIG. 2 is a front, partially cut-away view of the sponge cleaning device of FIG. 1, with the lid closed;

FIG. 3 is a side, partially cut-away view of the sponge cleaning device of FIG. 1 with the lid open;

FIG. 4 is a side, partially cut-away view of the sponge cleaning device of FIG. 1 with the lid closed;

FIG. 5 is a top view of a top or bottom shelf member used in the sponge cleaning device of FIG. 1; and

FIG. 6 is a top view of a shelf member usable for a jewelry cleaning application according to an exemplary embodiment of the present invention.

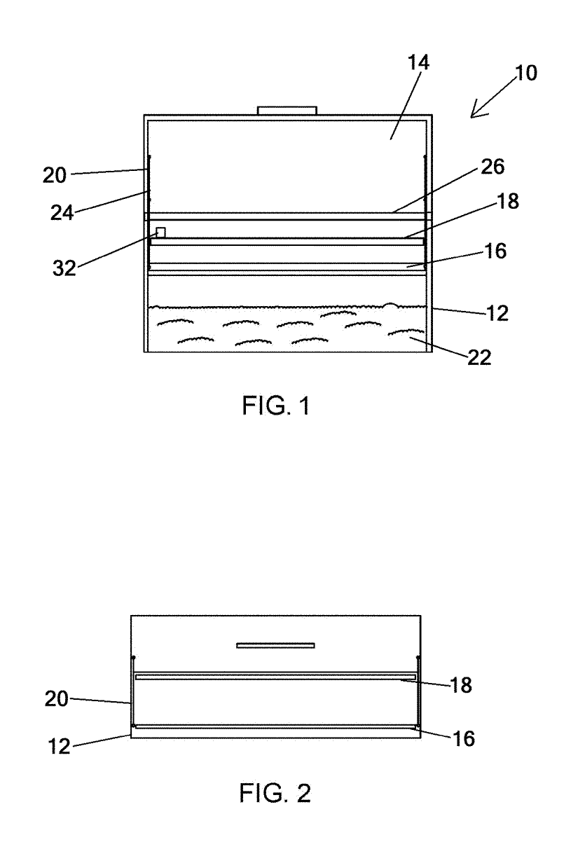

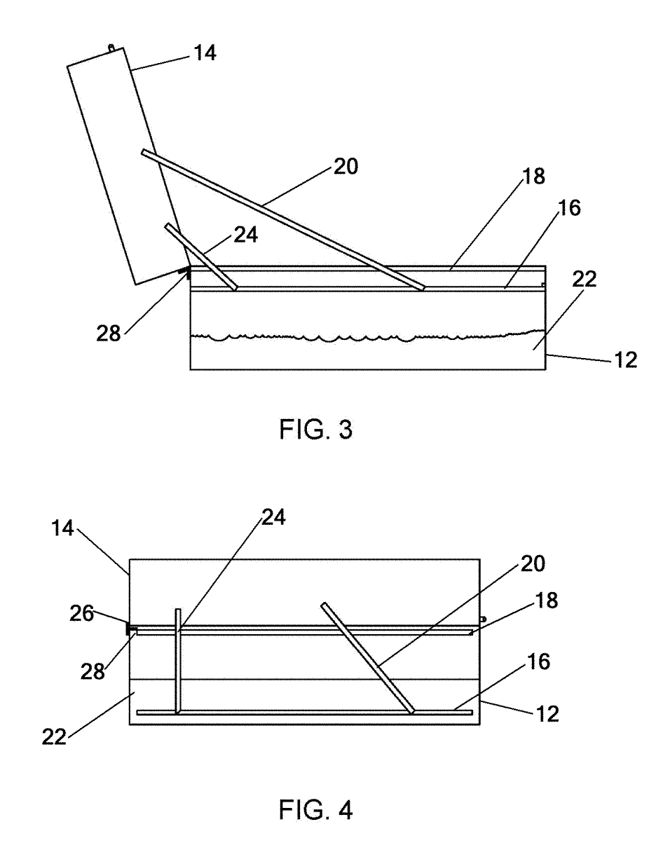

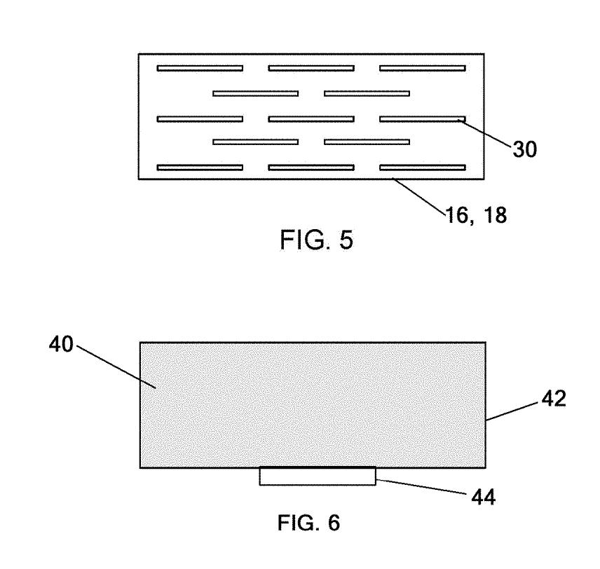

Unless otherwise indicated illustrations in the figures are not necessarily drawn to scale.

The invention and its various embodiments can now be better understood by turning to the following detailed description wherein illustrated embodiments are described. It is to he expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to he considered as an exemplification of the invention, and is not intended to limit the invention to the specific embodiments illustrated by the figures or description below.

As is well known to those skilled in the art, many careful considerations and compromises typically must be made when designing for the optimal configuration of a commercial implementation of any system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

As discussed above, the sponge is known to have the highest levels of bacteria in the home and more than the toilet seat. It is used to clean dishes, pots, pans and silverware. There are many ways to clean a sponge. The actual soaking in the proper fluid is the best way to remove the maximum amount of bacteria, so the sponge can be used again and again for a proper period of time. The sponge is used over and over by many people without the knowledge of the bacteria effects.

The proper cleaning and storage provide the best defense and, with the device of the present invention, providing the correct bacteria killing fluid, the battle is over.

The sponge cleaning and storage device is a multi-purpose unit. It raises and lowers the sponge into and out of the bacteria killing fluid without actual hand contact. It easily squeezes out the fluid after soaking by pressing the top shelf It holds the sponge ready for use on its upper squeeze shelf for everyday use. It is visually attractive by any sink by keeping the sponge hidden. It can also be used for scouring pads.

Broadly, an embodiment of the present invention provides a sponge cleaning device having a lid for enclosing and hiding a sponge when not in use. The sponge cleaning device has a bottom shelf that can be raised and lowered into a cleaning solution disposed in a base of the device. When the lid is closed, the bottom shelf lowers toward the base, causing a sponge resting on the bottom shelf to be lowered into the cleaning solution. When the lid is opened, the bottom shelf raised out of the cleaning solution and toward a top shelf. The top shelf can be movably disposed to compress the sponge when the sponge is on the bottom shelf and the lid is opened, thus squeezing out cleaning solution from the sponge. The top shelf can be movably disposed to permit the user to access the sponge and remove it from the bottom shelf for use.

Referring to the Figures, to store the sponge (not shown) without causing the sponge to contact the cleaning solution, the user can place the sponge on the top shelf 18 of the cleaning and storage device 10 (also referred to as device 10) and close the lid 14 over the base 12, creating a chamber inside for cleaning fluid 22. Fluid level marks on the inside of the cleaning device 10 can indicate maximum cleaning solution fill so as to avoid contact with the sponge when stored on the top shelf 18. In this configuration, the bottom shelf 16 may be moved into the cleaning solution 22, while the top shelf 18 is held in an upper position by one or more retaining members or by simply being attached to the base 12. The lid 14 can be closed to hide the sponge prior to use. A plurality of arms 20, 24 can interconnect the lid 14 and the lower shelf 16 to raise the lower shelf 16 to a first position adjacent the top shelf 18 when the lid 14 is open, the arms 20, 24 further configured to lower the lower shelf 16 to a second position adjacent a bottom surface 34 of the base member 12.

The sponge cleaning and storage device 10 can be formed in various sizes to accommodate various sized sponges. While the drawings show a space, such as a ½ inch space, between the top shelf 18 and the bottom shelf 16, this spacing may change depending on the sponge size.

The top shelf 18 may be movably disposed via various mechanisms. In some embodiments, the top shelf 18 may be hingedly connected to the back of the cleaning device 10, near a location where the lid 14 may be hingedly connected 26. The top shelf 18 may then be rotated downward to squeeze out the sponge or rotated upward to allow access to the sponge and the bottom shelf. In other words, by providing a hinge 28 for the top shelf 18, the top shelf 18 may pivot to press against the sponge when on the bottom shelf 16, so that a user can squeeze out the sponge by only touching the top shelf 18, avoiding excess or any contact with the cleaning solution 22. The user can then pick up the sponge and store it on the top shelf 18 for further draining prior to use.

The top shelf 18 and the bottom shelf 16 may be slotted or have holes 30 to permit the draining of fluid from the sponge or to permit cleaning solution to surround the sponge when lowered on the bottom shelf 16.

In some embodiments, the top shelf 18 can include one or more upwardly protruding members 32 to provide a location for a user to press down on the top shelf 18 against the sponge, or to grasp to raise the top shelf 18, without coming into direct contact with the shelf or cleaning fluid. In other embodiments, a region of the top shelf 18 can be formed without holes or slots to permit the user to depress the top shelf 18 against the sponge without cleaning solution moving through holes to contact the user.

While the above describes the use of the device for sponge cleaning and sanitizing, the device of the present invention may be useful for a variety of items that may benefit from soaking into a solution. For example, in some embodiments, the top shelf 18 may be formed as a screened or meshed shelf, as shown in FIG. 6, where jewelry may be placed and retained while, when closing the lid, the bottom shelf 16 moves downward into the cleaning solution. In this embodiment, the liquid in the base of the device may be a jewelry cleaning solution. Other uses where items on the shelf may benefit from contacting a solution are contemplated within the scope of the present invention. In some embodiments, the top shelf 18 may be the same as that described above and a tray 40 may be placed thereupon. The tray 40 may include upward extending sides 42 and a tab 44 for moving the tray 40 on and off the top or bottom shelf.

There are many ways to make the unit. It can be made in a variety of different materials such as plastic, enameled steel, stainless steel, ceramic, or the like, and must be waterproof and fluid resistant. This product can be made in any color or style to compliment the scheme of any kitchen or bathroom, or it can be used to decoratively hide soap in the bathroom.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Claim elements and steps herein may have been numbered and/or lettered solely as an aid in readability and understanding. Any such numbering and lettering in itself is not intended to and should not be taken to indicate the ordering of elements and/or steps in the claims.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. A cleaning device comprising:
a base member having sides extending from a bottom thereof;
a lid configured to close against tops of the sides of the base member;
a top shelf attached to at least one of the sides of the base member;
a lower shelf, positioned below the top shelf; and
a plurality of arms interconnecting the lid and the lower shelf, the arms configured to raise the lower shelf to a first position adjacent the top shelf when the lid is open, the arms further configured to lower the lower shelf to a second position adjacent a bottom surface of the base member.

2. The cleaning device of claim 1, wherein the first position results in the lower shelf being positioned from about one-half to about 1 inch from the top shelf.

3. The cleaning device of claim 1, further comprising a shelf hinge attaching the top shelf to a back side of the cleaning device.

4. The cleaning device of claim 3, further comprising a lid hinge connecting the lid to the back side of the cleaning device at a location above the shelf hinge.

5. The cleaning device of claim 3, wherein the top shelf is configured to pivot to cause at least a portion of the top shelf to move closer to the lower shelf and away from the lower shelf.

6. The cleaning device of claim 1, wherein the top shelf includes drainage slots formed therein.

7. The cleaning device of claim 1, wherein the lower shelf includes holes formed therein.

8. The cleaning device of claim 1, further comprising a mesh tray fitting onto one of the top shelf and the lower shelf.

9. The cleaning device of claim 8, wherein the mesh tray includes at least one handle extending from at least one side thereof.

10. A cleaning device comprising:
a base member having sides extending from a bottom thereof;
a lid configured to close against tops of the sides of the base member;
a top shelf attached to at least one of the sides of the base member;
a shelf hinge attaching the top shelf to a back side of the cleaning device;
a lid hinge connecting the lid to the back side of the cleaning device at a location above the shelf hinge;
a lower shelf, positioned below the top shelf; and
a plurality of arms interconnecting the lid and the lower shelf, the arms configured to raise the lower shelf to a first position adjacent the top shelf when the lid is open, the arms further configured to lower the lower shelf to a second position adjacent a bottom surface of the base member, wherein
the top shelf is configured to pivot to cause at least a portion of the top shelf to move closer to the lower shelf and away from the lower shelf.

11. The cleaning device of claim 10, wherein the first position results in the lower shelf being positioned from about one-half to about 1 inch from the top shelf.

12. The cleaning device of claim 10, wherein the top shelf includes drainage slots formed therein.

13. The cleaning device of claim 10, wherein the lower shelf includes holes formed therein.

14. The cleaning device of claim 10, further comprising a mesh tray fitting onto one of the top shelf and the lower shelf.

15. The cleaning device of claim 14, wherein the mesh tray includes at least one handle extending from at least one side thereof.

16. A method for cleaning and storing an item, comprising:
placing the item on a lower shelf of a cleaning device, the cleaning device including a base member having sides extending from a bottom thereof, a lid configured to close against tops of the sides of the base member, a top shelf attached to at least one of the sides of the base member, the lower shelf positioned below the top shelf, and a plurality of arms interconnecting the lid and the lower shelf, the arms configured to raise the lower shelf to a first position adjacent the top shelf when the lid is open, the arms further configured to lower the lower shelf to a second position adjacent a bottom surface of the base member;
closing the lid to cause the item to move into a cleaning solution positioned into the base member; and
opening the lid after a cleaning time to move the lower shelf out of the cleaning solution.

17. The method of claim 16, further comprising:
moving the item to the top shelf; and
closing the lid to store the item on the top shelf without the top shelf moving into the cleaning solution.

18. The method of claim 16, further comprising hingedly moving the top shelf toward the lower shelf to depress the item on the lower shelf after the lid is opened.

19. The method of claim 16, wherein the item is selected from a sponge and jewelry.
